(19) United States
(12) Patent Application Publication
(10) Pub. No.: US 2015/0066376 A1
(43) Pub. Date: Mar. 5, 2015

(54) NON-INVASIVE PRENATAL TESTING METHOD BASED ON WHOLE-GENOME TENDENCY SCORING

(71) Applicant: Welgene Biotech Co., Ltd., Taipei City (TW)

(72) Inventors: Chen-Hsiang YEANG, Taipei City (TW); Ming Chen, Taichung City (TW); Hung-Wei Shu, Taipei City (TW); Gwo-Chin Ma, Taichung City (TW); Yi-Shin Lin, Taipei City (TW); Shun-Min Chang, Taipei City (TW); Fu-Chian Chen, Taipei City (TW); Shou-Jen Kuo, Changhua County (TW)

(73) Assignee: Welgene Biotech Co., Ltd., Taipei City (TW)

(21) Appl. No.: 14/184,988

(22) Filed: Feb. 20, 2014

(30) Foreign Application Priority Data
Sep. 3, 2013 (TW) 102131625

(51) Int. Cl. G06F 19/00; G06F 19/22

(52) U.S. Cl. CPC G06F 19/3431; G06F 19/22
USPC 702/19

(57) ABSTRACT

Provided is a non-invasive prenatal testing method based on whole-genome tendency scoring and adapted to test whether a pregnant woman's fetus has autosomal aneuploidy. The method includes: creating a database of mₖ values which equal the averages of length proportions of health persons' chromosome k; obtaining the pregnant woman's and her fetus' chromosomal data yₖ from the pregnant woman's plasma; obtaining p values by the ratio of the yₖ values to the mₖ values; and analyzing p values to determine whether the target chromosome has chromosome aneuploidy. The comparable data is increased and thus test accuracy is enhanced by comparing the p values and the p values in a database. Due to an abundance of comparable data, the method of the present invention is accurate even when performed in the first trimester, such that pregnant women can know as soon as possible whether their fetuses' chromosomes are normal.

### BACKGROUND OF THE INVENTION

1. Field of the Invention

The present invention relates to prenatal examination methods for calculating the number of fetal chromosomes, and more particularly, to a non-invasive test in which a pregnant woman's blood is drawn and analyzed to determine whether the fetus' chromosomes are aneuploidy.

2. Description of the Prior Art

Prenatal diagnosis is performed on a fetus to detect congenital disorders, such as neural tube defects, chromosome abnormalities, and genetic disorders. Amniocentesis is the commonest method for screening for fetal chromosomal abnormalities.

Amniocentesis, which is technically based on cell culture and deoxyribonucleic acid (DNA) analysis, is a medical procedure used in prenatal diagnosis, in which a needle is inserted through a pregnant woman's abdominal wall, then through the wall of the uterus, and finally into the amniotic sac surrounding a developing fetus, to allow a small amount of amniotic fluid, which contains fetal tissues, to be sampled from the amniotic sac, and the fetal DNA is examined for genetic and congenital abnormalities. With the fetal DNA being examined directly, the precision of amniocentesis is beyond doubt. The best time to perform amniocentesis is 16^{th} to 18^{th} gestational weeks. Although amniocentesis is reliable and yields an absolutely accurate result, it is an invasive medical procedure and thus carries a 0.1% to 0.2% chance of miscarriage and a 0.05% chance of physical injury to the fetus. In view of the aforesaid drawbacks of the prior art, medical researchers are developing various methods for screening for chromosomal abnormalities.

In 1997, Professor Dennis Lo Yuk-ming et al. discovered that cell-free fetal DNA fragments could be extracted from a pregnant woman's plasma. The discovery enables non-invasive prenatal chromosomal test to take an innovative step forward, that is, drawing a pregnant woman's blood to analyze chromosomal aneuploidy by Next Generation Sequencing (NGS). However, the aforesaid innovative technique is still flawed with errors, because it does not obtain fetal chromosomes directly.

A conventional maternal blood screening method usually identifies a risky group by means of chromosome sequencing number expected value (Z-score) and performs evaluation by using the detection rate and the false positive rate as the screening criteria. The method is hereunder referred to as Z-score technique.

Z-score technique entails selecting a target chromosome, measuring the DNA fragment count of the target chromosome in the pregnant woman's blood and the DNA fragment count of all the chromosomes in the pregnant woman's blood, and defining yₖ as the ratio of the DNA fragment count of the target chromosome to the DNA fragment count of all the chromosomes, so as to compare the subject's yₖ value and the yₖ value of persons free from chromosomal abnormality and thereby calculate the probability that the subject will develop fetal chromosomal abnormalities.

Researchers put forth another blood screening method known as Normalized Chromosome Value (NCV) technique which entails selecting Yₖ and a reference chromosome, wherein there is a positive correlation between the reference chromosome and the target chromosome, and defining Y_{R} as the ratio of the DNA fragment count of the reference chromosome to the

DNA fragment count of all the chromosomes, so as to calculate a Sₖ value. The Sₖ value equals the ratio of yₖ to Y_{R}.

For example, a medical study indicates that, among human beings, chromosome 9 is positively correlated with chromosome 21 in terms of plasma cell-free DNA. Hence, to screen for Down's Syndrome (21-trisomy syndrome or T21), it is feasible to treat chromosome 21 as the target chromosome, and chromosome 9 as the reference chromosome.

Z-score technique and NCV technique have a serious drawback in common, that is, both of them yield a result in the form of a probability value instead of one which confirms whether the chromosome under test is abnormal. If the pregnant woman is unsatisfied with the probability value she gets, she will usually go ahead with amniocentesis in order to confirm her case.

In general, maternal blood screening is performed at the end of the first trimester (10^{th} to 13^{th} gestational weeks) and/or during the first half of the second trimester (14^{th} to 20^{th} gestational weeks). The amount of cell-free fetal DNA fragments in a pregnant woman's plasma increases with the gestational week; there are more cell-free fetal DNA fragments in the second trimester than in the first trimester, and thus maternal blood screening performed in the second trimester is more accurate than it is in the first trimester. However, pregnant women always want to know as soon as possible whether their fetuses have normal chromosomes.

In view of this, the inventor contemplates and studies the aforesaid issues and eventually invents a non-invasive prenatal testing method based on whole-genome tendency scoring.

### SUMMARY OF THE INVENTION

The present invention provides a non-invasive prenatal testing method based on whole-genome tendency scoring to perform non-invasive prenatal screening in the first trimester and with high precision.

In order to achieve the above and other objectives, the present invention provides a non-invasive prenatal testing method based on whole-genome tendency scoring to detect whether a pregnant woman's fetus has autosomal aneuploidy. The testing method comprises the steps of: (a) creating a database: obtaining and treating chromosome cell-free DNA fragment counts in at least one pregnant woman's plasma as a control sample to thereby obtain a mₖ value, wherein the pregnant woman and the pregnant woman's fetus do not have chromosomal quantity abnormality, wherein the mₖ value equals the average of the length proportions of chromosome k, where k=1, 2, . . . , 22, and Σₖ₌₁²²mₖ=1; (b) obtaining a blood sample: obtaining the pregnant woman's blood sample and separating plasma from the blood sample; (c) obtaining chromosome cell-free DNA fragment count ratios: obtaining from the pregnant woman's plasma the pregnant woman's and her fetus' chromosomal data yₖ, the yₖ value being the ratio of the pregnant woman's read count of chromosome k to the pregnant woman's total read count of chromosomes; (d) obtaining p values: the p values equal ratios of the yₖ values to the mₖ values, respectively, including the ratio of the yₖ value of a target chromosome to the mₖ value and the ratio of the yₖ value of at least a reference chromosome to the in value; and (e) analyzing p values: comparing the p values to determine whether the target chromosome has chromosome aneuploidy.

According to the present invention, the advantages of the non-invasive prenatal testing method based on the whole-genome tendency scoring are as follows: increasing comparable data and thus enhancing the accuracy of the test, by comparing the pregnant woman's p values and a database's p values; given the abundant comparable data, the prenatal testing method of the present invention is very accurate despite scarcity of cell-free fetal DNA fragments in the pregnant woman's plasma during the first trimester, such that the pregnant woman can know as soon as possible whether her fetus has normal chromosomes; and the prenatal testing method of the present invention merely requires sampling the pregnant woman's blood sample and thus is a non-invasive medical procedure which is safe and reliable to the fetus and the pregnant woman.

The technique and measures taken to achieve the above objectives of the present invention and other advantages thereof are illustrated with a preferred embodiment and the accompanying drawings and described in detail below.

### BRIEF DESCRIPTION OF THE DRAWINGS

Objectives, features, and advantages of the present invention are hereunder illustrated with specific embodiments in conjunction with the accompanying drawings, in which:

FIG. 1 is a flow chart of an embodiment of the present invention;

FIG. 2 is a schematic view of the result of a clinical experiment performed according to the present invention;

FIG. 3 (PRIOR ART) is a schematic view of the result of a clinical experiment performed by conventional Z-score technique;

FIG. 4 (PRIOR ART) is a schematic view of the result of a clinical experiment performed by conventional NCV technique; and

FIG. 5 is a schematic view of simulation data of comparison of the present invention and the other two conventional methods.

### DETAILED DESCRIPTION OF THE PREFERRED EMBODIMENTS

Like components described hereunder are denoted with like reference numerals.

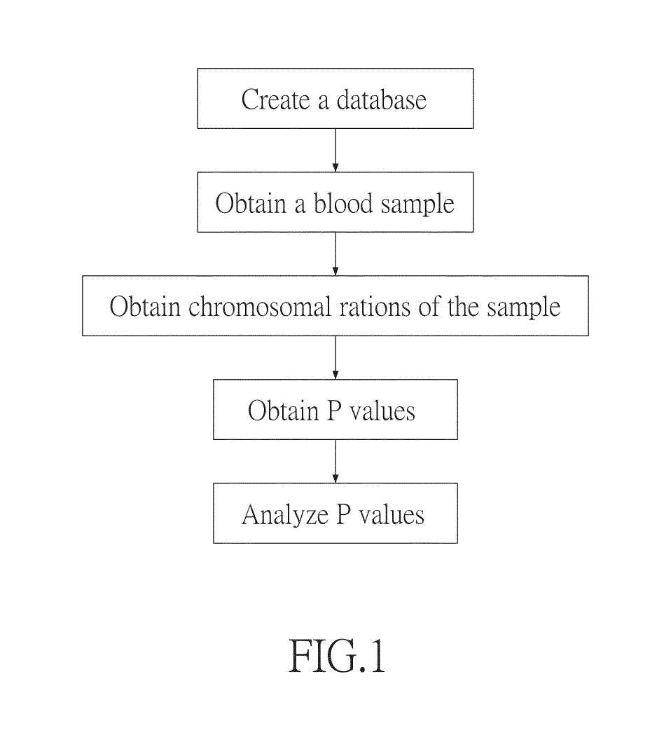

Referring to FIG. 1, there is shown a diagram of a non-invasive prenatal testing method based on whole-genome tendency scoring according to a preferred embodiment of the present invention and adapted to test whether a pregnant woman's fetus has autosomal aneuploidy. The testing method comprises the steps of:

(a) creating a database: obtaining and treating chromosome cell-free DNA fragment counts in at least one pregnant woman's plasma as a control sample to thereby obtain a mₖ value, wherein the pregnant woman and the pregnant woman's fetus do not have chromosomal quantity abnormality, wherein the mₖ value equals the average of the length proportions of chromosome k, where k=1, 2, . . . , 22, and Σₖ₌₁²²mₖ=1;

(b) obtaining a blood sample: obtaining the pregnant woman's blood. sample and separating plasma from the blood sample;

(c) obtaining chromosome ratios: obtaining from the pregnant woman's plasma the pregnant woman's and her fetus' chromosomal data yₖ, the yₖ value being a ratio of the pregnant woman's read count of chromosome k to the pregnant woman's total read count of chromosomes;

(d) obtaining p values: the p values equal ratios of the yₖ values to the mₖ values, respectively, including the ratio of the yₖ value of a target chromosome to the mₖ value and the ratio of the yₖ value of at least one reference chromosome to the mₖ value, wherein, depending on the target chromosome under test, the target chromosome includes chromosome 13, chromosome 18, chromosome 21, and even the other autosomes; and

(e) analyzing p values: comparing the p values to determine whether the target chromosome has chromosome aneuploidy.

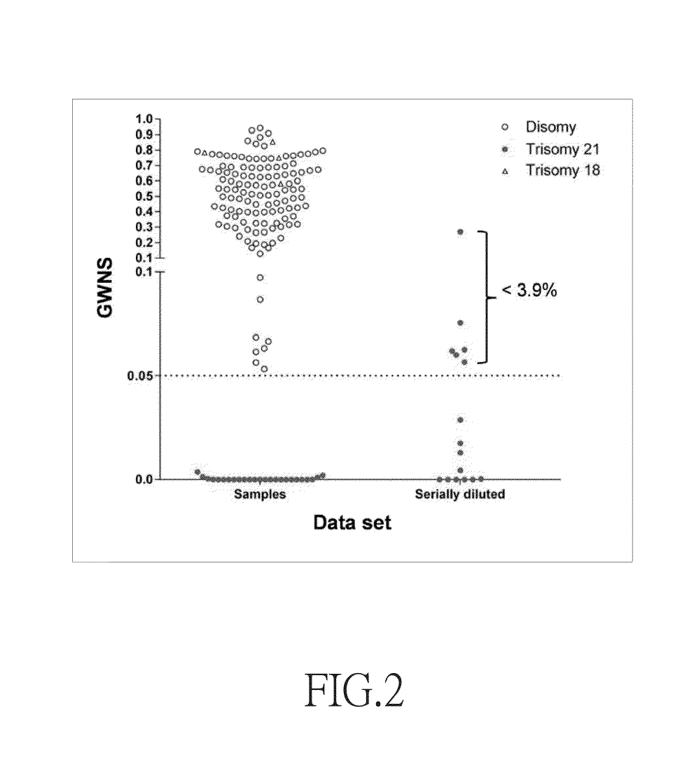

Essential components and configurations of the present invention embodiment are described above. Referring to FIG. 2, the advantages and ways of effectuating the embodiments of the present invention are analyzed and confirmed with a clinical experiment performed by the inventor of the present invention on 208 pregnant women, of which 55 have their chromosome control samples randomly selected to create a database (wherein the 55 pregnant women and their fetuses do not have chromosomal quantity abnormality), 124 with fetuses free of chromosomal quantity abnormality are tested with the database, four have fetuses diagnosed with Edwards Syndrome (18-trisomy syndrome or T18), and 25 have fetuses diagnosed with Down's Syndrome (T21). To evaluate whether the present invention is applicable to pregnant women during the first trimester which features scarcity of cell-free fetal DNA fragments in plasma, the inventor of the present invention dilutes the plasma DNA samples of four of the Down's Syndrome fetus-carrying women consecutively and tests them for T21 to yield the result shown in the diagram. The data (indicated by GWNS) displayed on the left of the diagram is collected before dilution, with GWNS value of 0.05 being the boundary, and the test reveals that red data indicative of presence of T21 separates significantly from white data (pertaining to fetuses free of chromosomal quantity abnormality) indicative of absence of T21 and blue data (pertaining to T18 fetuses) indicative of absence of T21, thereby proving that, with the method of the present invention, T21 screening can be performed in a reliable and precise manner. The data displayed on the right of the diagram is collected after consecutive dilution, wherein the range of the T21-related samples is elongated, but it is obviously evident all the samples with cell-free fetal DNA concentration greater than 3.9% can lead correctly to the confirmation of T21.

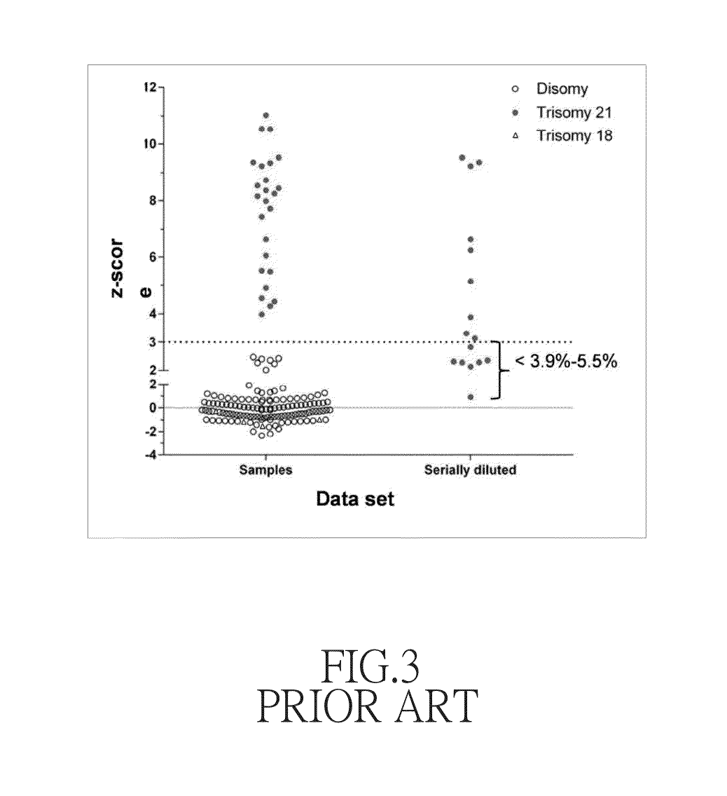

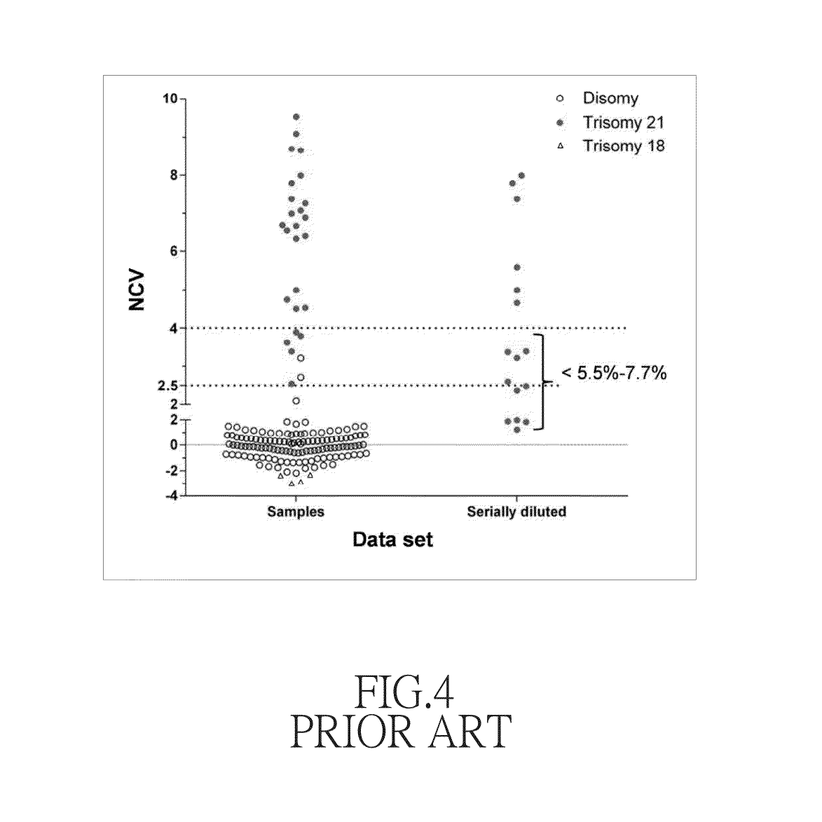

Referring to FIG. 3 and FIG. 4, for the sake of contrast, there are shown diagrams of data obtained by conventional Z-score technique and NCV technique performed on the same 208 pregnant women who underwent the aforesaid clinical experiment. Referring to FIG. 3, data is obtained with Z-score technique during 11^{th} to 12^{th} gestational weeks, with Z-score value of 3 being the boundary. The data displayed on the left of FIG. 3 is collected before dilution, wherein, although non-T21-related white and blue data is positioned slightly proximate to T21-related red data, the red data can still be distinguished significantly from white and blue data; however, due to the proximity of data, misinterpretation is more like to occur. The data displayed.

on the right of FIG. 3 is collected after consecutive dilution, wherein it reveals that red data between 3.9% and 5.5% cannot be accurately interpreted to indicate T21, and that is the reason why a high degree of accuracy cannot be attained unless the cell-free fetal DNA fragments are abundant.

Referring to FIG. 4, the data displayed is obtained with NCV technique during the second trimester, with NCV values being less than 2.5 and greater than 4 and serving as the boundary which distinguishes normality from abnormality. The data displayed on the left of FIG. 4 is collected before dilution, wherein non-T21-related white data and T21-related red data are partially mixed, and thus it is difficult to distinguish white data from red data within the range of 2.5 to 4. The data displayed on the right of FIG. 4 is collected after consecutive dilution, wherein it reveals that red data falls within a blurred area obviously when the cell-free fetal DNA concentration is less than 5.5% to 7.7%. It is impossible to confirm that the test result has a wider range of blurredness than Z-score technique does.

The data of the aforesaid experiments indicates that conventional non-invasive testing techniques, such as Z-score technique, performed during the second or third trimester are quite accurate. However, pregnant women and/or their family members inevitably want to confirm as soon as possible whether the fetuses have T21 or any other chromosomal quantity abnormalities. Due to the scarcity of cell-free fetal DNA fragments in pregnant women's plasma during the first trimester, conventional non-invasive prenatal testing techniques performed during the first trimester lack stable accuracy.

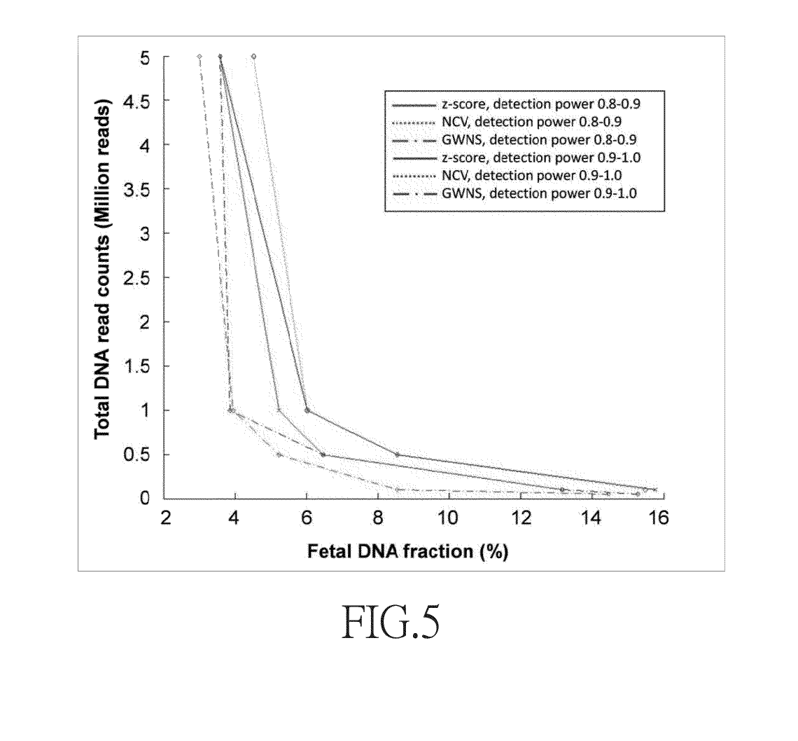

Referring to FIG. 5, to understand whether the method of the present invention is effective in performing T21 screening or other chromosomal quantity abnormality screening during the first trimester, the inventor of the present invention performs iso-quality curve comparison on NGS sequencing results obtained from the samples of 64 pregnant women with fetuses free of chromosomal quantity abnormality and 22 pregnant women with fetuses diagnosed with T21 abnormality. Then, the inventor analyzes the relation between the NGS DNA sequencing quantity required for Z-score technique, NCV technique, and the method of the present invention and the fetal DNA concentration fraction required for Z-score technique, WV technique, and the method of the present invention, under specific test accuracy, and then plots a broken line graph shown in FIG. 5. As shown in the diagram, the horizontal axis represents the concentration fraction of fetal DNA in the sample, wherein a low concentration fraction of fetal DNA in the sample indicates a pregnant woman's sample obtained in the first trimester. By contrast, a high concentration fraction of fetal DNA in the sample indicates a pregnant woman's sample obtained in the second and third trimesters. The vertical axis represents the NGS DNA sequencing quantity which has to be read so as for a technique/method to be performed to achieve specific test accuracy at a specific fetal DNA concentration fraction. As shown in the diagram, the method (indicated by GWNS in the diagram) of the present invention always features a number line lower than that of the other two conventional techniques. Hence, the method of the present invention is more accurate than the other two conventional techniques in T21 screening or the other chromosomal quantity abnormality screening in the same trimester with the same NGS DNA sequencing quantity.

As indicated above, the present invention has industrial applicability, novelty, and non-obviousness.

What is claimed is:

1. A non-invasive prenatal testing method based on whole-genome tendency scoring and adapted to test whether a pregnant woman's fetus has autosomal aneuploidy, the testing method comprising the steps of:
(a) creating a database: obtaining and treating chromosome cell-free DNA fragment counts in at least a pregnant woman's plasma as a control sample to thereby obtain a mₖ value, wherein the pregnant woman and the pregnant woman's fetus do not have chromosomal quantity abnormality, wherein the mₖ value equals an average of length proportions of chromosome k, where k=1, 2, . . . , 22, and Σₖ₌₁²²mₖ=1;
(b) obtaining a blood sample: obtaining the pregnant woman's blood. sample and separating plasma from the blood sample;
(c) obtaining chromosome ratios: obtaining from the pregnant woman's plasma the pregnant woman's and her fetus' chromosomal data yₖ, the yₖ value being a ratio of the pregnant woman's read count of chromosome k to the pregnant woman's total read count of chromosomes;
(d) obtaining p values: the p values equal ratios of the yₖ values to the mₖ values, respectively, including the ratio of the yₖ value of a target chromosome to the mₖ value and the ratio of the yₖ value of at least a reference chromosome to the mₖ value; and
(e) analyzing p values: comparing the p values to determine whether the target chromosome has chromosome aneuploidy.

2. The non-invasive prenatal testing method based on whole-genome tendency scoring of claim 1, wherein the target chromosome comprises one selected from the group consisting of chromosome 13, chromosome 18, and chromosome 21.
